(19) United States
(12) Patent Application Publication
(10) Pub. No.: US 2012/0105360 A1
(43) Pub. Date: May 3, 2012

(54) WRIST-WORN ELECTRONIC DEVICE AND TOUCH SENSITIVE ELECTRONIC DEVICE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/070,445

(22) Filed: Mar. 23, 2011

(30) Foreign Application Priority Data
Oct. 29, 2010 (TW) 99137283

(51) Int. Cl. G06F 3/044; G06F 3/041

(52) U.S. Cl. 345/174; 345/173

(57) ABSTRACT

A wrist-worn electronic device includes a display panel having a convex viewing surface and displaying at least one selectable item. A touch panel is arranged over the display panel. A processing unit is to execute a preset operation corresponding to one of the at least one selectable item when the one selectable item is selected or an area of the touch panel surrounding the selectable item.

### BACKGROUND

1. Technical Field

The present disclosure relates to a wrist-worn electronic device and a touch sensitive electronic device.

2. Description of Related Arts

Small touch sensitive electronic devices such as wrist watches have been known in the art. Due to the small size of the electronic devices, a user needs to view the watch to identify and touch the exact position of a selectable item. Even when there is only one selectable item on the display of the electronic device, a user still needs to view first and then operate. It would be convenient and useful if such a view-and-operate process could be eliminated.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic planar view of a user interface displayed on a display of a touch sensitive electronic device, in accordance with an embodiment.

FIG. 2 is a block diagram of the touch sensitive electronic device of FIG. 1.

FIG. 3 is a schematic, side view of the touch sensitive electronic device of FIG. 1.

### DETAILED DESCRIPTION

Embodiments of the present disclosure will now be described in detail below, with reference to the accompanying drawings.

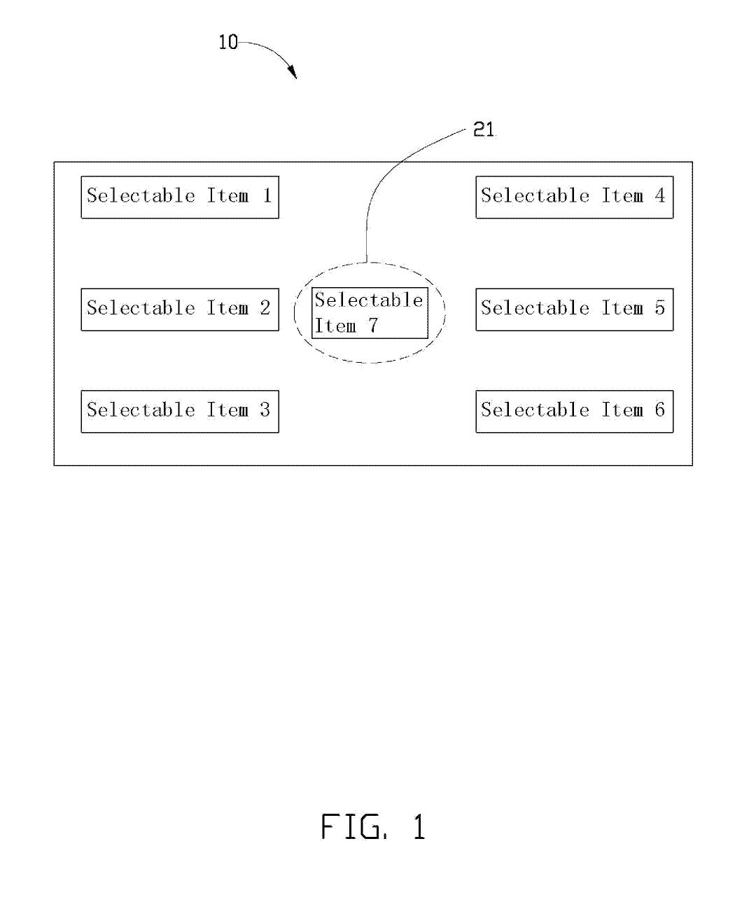

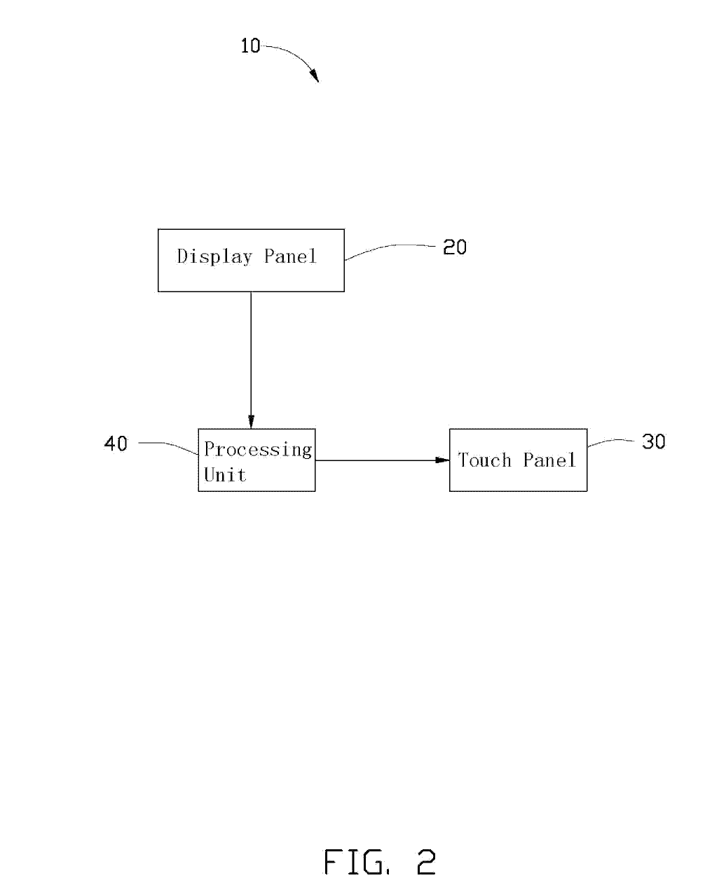

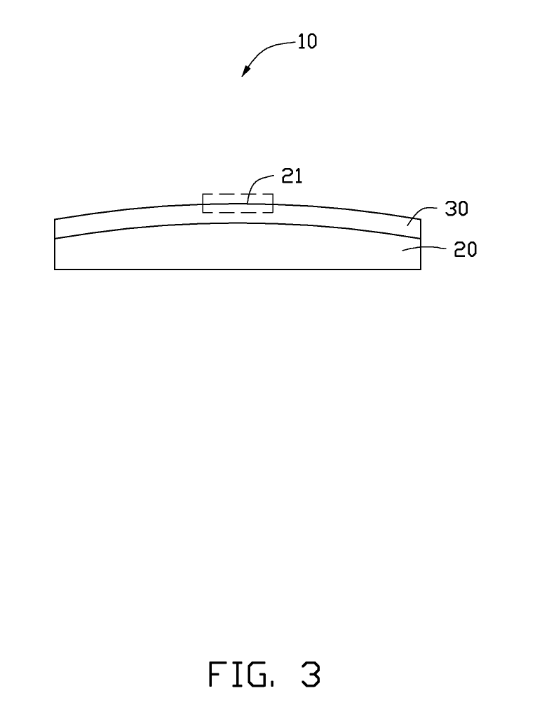

Referring to FIGS. 1-3, a touch sensitive electronic device 10 includes a display panel 20 and a touch panel 30 arranged over the display panel 20. The display panel 20 may have a flat viewing surface or a convex viewing surface (FIG. 3) used to display information. In the embodiment, the touch panel 30 may be a mutual capacitance touch-screen or a self capacitance touch-screen. The touch sensitive electronic device 10 may be a wrist watch.

The display panel 20 can display a user interface including one or more selectable items. For example, as shown in FIG. 1, the user interface displayed on the display panel 20 includes 7 selectable items.

The touch sensitive electronic device 10 further includes a processing unit 40. When a user touches the position occupied by a selectable item, the processing unit 40 executes a preset operation corresponding to the selectable item. In the embodiment, when a user touches a position within a predetermined area surrounding one selectable item, such as selectable item 7 shown in FIG. 1 surrounded by an area 21, the processing unit 40 executes a preset operation corresponding to the selectable item.

With such configuration, a user can select a selectable item by touching near or on the position occupied by the selectable item. The selection of a selectable item thus is not limited to accurately touching the position occupied by the selectable item, and so may be done by touch without having to actually view the location of the selectable item, which is convenient.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A wrist-worn electronic device comprising:
a display panel having a convex viewing surface and displaying at least one selectable item;
a touch panel arranged over the display panel; and
a processing unit to execute a preset operation corresponding to one of the at least one selectable item when the one selectable item is selected or a predetermined area of the touch panel surrounding the one selectable item.

2. The wrist-worn electronic device according to claim 1, wherein the touch panel is a mutual capacitance touch-screen.

3. The wrist-worn electronic device according to claim 1, wherein the touch panel is a self capacitance touch-screen.

4. The wrist-worn electronic device according to claim 1, wherein the wrist-worn electronic device is a wrist-worn watch.

5. A touch sensitive electronic device comprising:
a display panel displaying at least one selectable item;
a touch panel arranged over the display panel; and
a processing unit to execute a preset operation corresponding to one of the at least one selectable item when the one selectable item is selected or an area of the touch panel surrounding the one selectable item.

6. The touch sensitive electronic device according to claim 5, wherein the touch panel is a mutual capacitance touch-screen.

7. The touch sensitive electronic device according to claim 5, wherein the touch panel is a mutual capacitance touch-screen.

8. The touch sensitive electronic device according to claim 5, wherein the touch sensitive electronic device is a wrist-worn watch.
